(19) United States
(12) Patent Application Publication
(10) Pub. No.: US 2024/0013128 A1
(43) Pub. Date: Jan. 11, 2024

(54) COMPUTER-IMPLEMENTED METHOD FOR DETERMINING A SUSTAINABILITY SCORE

(71) Applicant: BASF SE, Ludwigshafen am Rhein (DE)

(72) Inventors: Marina Grace Dickens Leed, Ludwigshafen (DE); Gazi Tuerkoglu, Ludwigshafen (DE); Wilhelm Keller, Ludwigshafen (DE); Martina Solfrank, Ludwigshafen (DE); Robert Anthony Keller, Summit, NJ (US); Oilver Reich, Ludwigshafen (DE); David Leino Calleja, Moscow (RU); Li Noi Lilian Hoh, Ludwigshafen (DE); Oliver Kuhn, Ludwigshafen (DE); Shyam Sundar Sathyanarayana, Ludwigshafen (DE); Kai Pahnke, Ludwigshafen (DE); Tobias Eltze, Ludwigshafen (DE); Christian Beil, Ludwigshafen (DE)

(73) Assignee: BASF SE, Ludwigshafen am Rhein (DE)

(21) Appl. No.: 18/253,713

(22) PCT Filed: Nov. 19, 2021
(86) PCT No.: PCT/EP2021/082265

§ 371 Date: May 19, 2023

(30) Foreign Application Priority Data
Nov. 20, 2020 (EP) 20209008.0

(51) Int. Cl. G06Q 10/0639; H04L 9/00; G06K 19/06; G06K 7/10; G06Q 10/30

(52) U.S. Cl. CPC G06Q 10/06393; H04L 9/50; G06K 19/06037; G06K 7/10; G06Q 10/30

(57) ABSTRACT

A computer-implemented method can be used for determining a sustainability score. The method involves providing a computer-based database containing entries on a plurality of markers each identifying a specific plastic compound; receiving scan data from a sample of a plastic compound; identifying a marker in the sample of the plastic compound based on the received scan data and the plurality of markers of the database; and determining a sustainability score based on the identified marker of the sample of the plastic compound.

### FIELD OF THE INVENTION

The present disclosure relates to a computer-implemented method for determining a sustainability score, a computer-program element for such a method, a computer readable medium storing such a computer-program element, a plastic compound handling device, a system for determining such a sustainability score and a use of a computer-based database in such a method.

### BACKGROUND OF THE INVENTION

Plastics show substantial benefits in terms of low weight, durability, low cost, applicability at wide temperature ranges, good temperature and light resistance as well as easy processing capabilities. Due to these benefits, the global demand of plastic increases every year and therefor the global production of plastic comprises a three-digit amount of million tons a year. A significant share of plastic is used for packaging, automotive, electrical goods. After use or end of lifetime only a small share of the generated plastic waste is reused. Recycling of plastic poses an option to reduce plastic waste and to save natural resources. Recycling of plastic waste requires separation and a sorting of the plastic waste due to the big variety of polymer types, grades, blends and/or additives. Therefor sorting is a major issue for recycling of plastic waste. Recycling has a significant effect on economic aspects of recycling of plastic waste and on a sustainability of plastics in a value chain.

In view of this, it is found that a further need exists to provide a method for recycling plastics.

### SUMMARY OF THE INVENTION

It is therefore an object of the present invention to provide a method to increase the sustainability of plastic products, in particular a method for recycling plastics.

These and other objects, which become apparent upon reading the following description, are solved by the subject-matter of the independent claims. The dependent claims refer to preferred embodiments of the present disclosure.

According to a first aspect of the present disclosure a computer-implemented method for determining a sustainability score is provided, comprising the steps of: providing a computer-based database comprising entries on a plurality of markers each identifying a specific plastic compound; receiving scan data from a sample of a plastic compound; identifying a marker in the sample of the plastic compound based on the received scan data and the plurality of markers of the database; determining a sustainability score based on the identified marker of the sample of the plastic compound.

In other words, the present disclosure proposes to tag unambiguously a plastic compound with markers and thereby generating an ID for the plastic compound. Properties of the plastic compound such as polymer type, grade, blend, number of reuse, sustainability score etc. are assigned to the ID. Information data of the ID and the properties of the plastic compound are stored in a database. By scanning, the plastic compound, the markers and therefor the ID of the plastic compound are determined and matched with the database. The result of the matching reveals the properties of the plastic compound such as the type of the plastic or the content of recycled material or the sustainability score. Hence, it is possible for a user, e.g. a contract manufacturer of plastic parts, to determine the sustainability score of the plastic compound, or e.g. an OEM of products to determine the sustainability score of the plastic part of the contract manufacturer used in the product, or for an end customer to determine the sustainability score of the product provided by the OEM. This may also be advantageous for recycling companies to sort plastic waste because beside the sustainability score other data such as polymer type, grade or additives may be revealed. Further, this may also be advantageous for plastic compound manufacturers to get information, i.e. sustainability score, polymer type, grade or additives of the plastic waste, which may further be used for producing a new recycled plastic compound. The proposed method may be advantageous to reveal the true sustainability score and/or material composition of the plastic compound beside the initial production of the plastic compound in all stages of a life cycle of the plastic compound, i.e. at least semi-finished product, product, waste, sorted waste, recycled raw material. The proposed method may be advantageous to provide a true and efficient traceability of plastic compounds. The proposed method may be advantageous for establishing an efficient recycling economy of plastic parts. The proposed method may be further advantageous to serve as a basis for product curriculum vitae comprising the sustainability score, and wherein further information (e.g. produced products with the specific plastic compound) is added to the curriculum vitae and stored in database. The proposed method may further be advantageous to reduce plastic waste and to increase an amount of recycled plastic waste.

The term sustainability score is to be understood broadly in the present case and comprises a figure configured to present information about the sustainability of a plastic compound, wherein the sustainability preferably relates to the content of recycled material of the plastic compound and/or the number recycling loops of the recycled material of the plastic compound. The sustainability score may comprise a metric, e.g. a verbal coding “bad”, “good”, “very good” or a color coding “red”, “orange”, “green” or a number coding “1”, “2”, “3”. The sustainability score is not limited to the mentioned examples. The sustainability score may be based on data submitted by a master batcher and converter for an OEM, a Retailer, or End customer. The term computer-based database is to be understood broadly in the present case and comprises any database or data system, which is configured to store and manage data. The database may be central or decentral organized and may comprise different access authorizations to different users (e.g. read, read/write etc.). The database may be stored and executed on a cloud server. The database may be realized as a block chain network. The block chain may increase a protection against fake data and therefor increase the trust of customers. The block chain may increase analysis capabilities (e.g. determining loop number of recycled plastic compound). The term entry is to be understood broadly in the present case and comprises any data, which can be stored in a database, preferable the term entry relates to an ID of a plastic compound in the present case, e.g. a binary code. The term marker is to be understood broadly in the present case and comprises elements configured to disclose an information relating to a plastic compound ID. The term marker may comprise chemical tracers, i.e. molecules embedded in the plastic resin, acting as a binary code as the molecule is either present or not. Such chemical tracers show various spectroscopic properties and are therefore detectable (e.g. being florescent under UV light). By adding different chemical tracers, each with unique spectra, it is possible to create codes, which serve as entries of the database. These chemical tracers may be advantageous because they are insensitive to deformation or other physical stress and hence improve the detectability of plastic compound during the life cycle. The term marker may further comprise QR-data, digital watermarks. The term scan data is to be understood broadly in the present case and comprises any data received from a scan and/or a detection process. Preferably, scan data comprises data from spectroscopic analysis and optical scanner (e.g. a camera of smartphone). The term plastic compound is to be understood broadly in the present case and comprises any plastic material in any possible stages of the life cycle or value chain of the plastic material. Preferably the term plastic compound comprises plastic feedstock (e.g. PE, PP, PET feedstock), semi-processed plastic material (e.g. semi-finished door handle), finished plastic material (e.g. PET bottle, packaging).

In an embodiment the computer-implemented method comprises the steps of: receiving a block chain storing a plurality of scan data of samples, a plurality of identified markers of samples and/or a plurality of sustainability scores of samples; uploading into the block chain the received scan data of the sample, the identified marker of the sample and/or the determined sustainability score of the sample. The term block chain is well known in the state of the art and comprises in the present case a growing list of data/records that are linked using cryptography. The data/records comprises in the present a plurality of scan data of samples, a plurality of identified markers of samples and/or a plurality of sustainability scores of samples. The data/records is not limited to these examples. The data/records may also comprise timestamps and transaction data and related data to products of the sample (e.g. feedstock, semi-finished product, end product). By uploading a plurality of scan data of samples, a plurality of identified markers of samples and/or a plurality of sustainability scores an open ledger is extended due to a new record/entry. The ledger may be a distributed ledger, wherein every user may have a copy and may be able to generate a new entry and wherein the new entry may have to be validated by every user. In sum, this may be advantageous to increase a transparency of different stages of the life cycle and/or treatments of a specific plastic feedstock. This may further may generate new data points related to the specific feedstock compound and increase analysis capabilities. This may further protect a user from deceptive entries/data related to a specific plastic feedstock (e.g. plurality of identified markers leads to fake data and reveals a deceptive sustainability score due to logic errors detected in the block chain). In other words the scan data of specific plastic feedstock is recorded in the block chain at a transaction (e.g. any scan) and hence reveal the curriculum vitae of the feedstock and further products related to the feedstock (e.g. semi-finished product, product, waste). By use of a block chain, an authentication data may be provided based on data entries stored by upstream users along a life cycle of the feedstock compound. For access to the authentication data and sustainability scores an app may be used by customer/user.

In an embodiment the step of determining the sustainability score comprises: identifying in the block chain at least one data entry associated with the identified marker of the sample; determining the sustainability score based on the at least one data entry and the identified marker. In other words the identified markers of the sample are matched with existing entries comprising the identified markers. This may reveal the history of the specific plastic feedstock. This may reveal the number of reuses/loops of a specific plastic feedstock. E.g. a specific plastic feedstock is produced for plastic bottles, in case you find the specific plastic feedstock in another product (e.g. tooth brush) you can derive a reuse of the specific plastic feedstock. Such intermediate result is used to determine the sustainability score. This may be advantageous to refine the determination of the sustainability score.

In an embodiment, the step of identifying the marker comprises determining a type and/or a quantity of the marker in the sample of the plastic compound. The type of the marker may comprise the elements of the periodic system. By determining the type of the marker, the ID of the specific plastic feedstock is determined. By determining the quantity of the marker the share of recycled plastic feedstock may be determined. This may be advantageous to determine the sustainability score. The determining of the marker may comprise UV detection technique, a near infra-red detection technique, mid infra-red detection technique, an X-ray fluorescence detection technique, neuron activation technique or a magnetic detection technique.

In an embodiment, the step of identifying the marker comprises determining a weight portion of the marker in the sample of the plastic compound. By determining the marker and its volume content in a sample, you can also derive the weight content by calculation. This may be advantageous to refine a sustainability score of the product due to a more specific description of the material composition of the sample of the plastic compound.

In an embodiment, the method comprises the step of determining based on the sustainability score an emission footprint, in particular a CO2 footprint, over the lifetime of the sample of the plastic compound. In other words, the sustainability score is further processed with additional data (e.g. content of recycled material, recycling loops, original CO2 footprint of unrecycled plastic compound) to calculate the CO2 footprint. The CO2 footprint may be provided from the database and/or block chain. The CO2 footprint may comprise any steps of a supply chain of the plastic compound. The sustainability score also may take into account the CO2 footprint and/or the loops of recycling. In sum, this may be advantageous to provide a user refined information of a plastic compound used in a product.

In an embodiment, the method comprises the step of: determining based on the sustainability score a fluid usage, in particular a water usage, over the lifetime of the sample of the plastic compound. The water usage may comprise any used water during one or more steps of the lifetime of the sample plastic compound (plastic compound production, further processing, waste sorting, recycling, further compound production). The fluid usage may comprise current data and/or future data from forecasts. The water usage may be provided from the database and/or block chain. The fluid usage may be advantageous to reveal further environmental figures and consequences of the use of the product compared to other products.

In an embodiment, the method comprising the step of: generating a signal, which comprises the command to display the determined sustainability score on a user interface. A user, which may scan to product (e.g. a QR code placed on a suitcase), is provided with the sustainability score of the product comprising the plastic compound. A user, which may scan the sample of the plastic compound with spectroscopy and further processes the data with the method, is provided with sustainability score of the sample of the plastic compound. The score may be displayed on a screen of smartphone, desktop pc. In sum, this may increase the applicability of the method and user friendliness.

In an embodiment a method is provided, wherein the marker is selected from the group consisting of UV marker, XRD marker, XRF marker, QR code and/or steganographic feature.

In an embodiment a method is provided, wherein further information is added to specific plastic compound by a user executing the method, wherein the further information preferably comprises a stage in value chain and/or a product type. This may be advantageous to certify recycled content.

In an embodiment a method is provided, wherein user of the block chain validate every new entry. This may advantageous to increase protection against fake entries.

In an embodiment, a method is provided, wherein the sample of the plastic compound comprises one or more elements selected from the group consisting of: low density polyethylene (LDPE), linear LDPE (LLDPE), high density polyethylene (HDPE), polyoxmethylene (POM) polypropylene (PP), polyamide (PA), poly ethylene terephthalate (PET), poly butylene terephthalate (PBT), acrylnitril-butadiene-styrene (ABS), polymethylmethacrylate (PMMA), thermoplastic polyurethane (TPU), polystyrene (PS), polylactic acid (PLA), polyvinylchloride (PVC) or polycarbonate (PC).

In an embodiment a method is provided further comprising: providing a determined sustainability score suitable for controlling the further processing of the plastic compound.

In an embodiment a method is provided further comprising: providing a determined sustainability score suitable for validating a sustainability score of the plastic compound, wherein preferably the content of recycled material and/or the number recycling loops of the recycled material of the plastic compound is validated.

A further aspect of the present disclosure relates to a Computer-program element, which, when executed, instructs a processor to perform any one of the steps of the above described method. The computer program element might therefore be stored on a computing unit, which might also be part of an embodiment. This computing unit may be configured to perform or induce performing of the steps of the method described above. Moreover, it may be configured to operate the components of the above described system. The computing unit can be configured to operate automatically and/or to execute the orders of a user. A computer program may be loaded into a working memory of a data processor. The data processor may thus be equipped to carry out the method according to one of the preceding embodiments. This exemplary embodiment of the present disclosure covers both, a computer program that right from the beginning uses the present disclosure and computer program that by means of an update turns an existing program into a program that uses the present disclosure. Moreover, the computer program element might be able to provide all necessary steps to fulfil the procedure of an exemplary embodiment of the method as described above. According to a further exemplary embodiment of the present disclosure, a computer readable medium, such as a CD-ROM, USB stick or the like, is presented wherein the computer readable medium has a computer program element stored on it which computer program element is described by the preceding section. A computer program may be stored and/or distributed on a suitable medium, such as an optical storage medium or a solid state medium supplied together with or as part of other hardware, but may also be distributed in other forms, such as via the internet or other wired or wireless telecommunication systems. However, the computer program may also be presented over a network like the World Wide Web and can be downloaded into the working memory of a data processor from such a network. According to a further exemplary embodiment of the present disclosure, a medium for making a computer program element available for downloading is provided, which computer program element is arranged to perform a method according to one of the previously described embodiments of the present disclosure.

A further aspect of the present disclosure relates to a Computer readable medium storing the above described computer program element.

A further aspect of the present disclosure relates to a plastic compound handling device, comprising: a wavelength scanner; a programmable controller; wherein the wavelength scanner is configured for scanning a sample of a plastic compound; wherein the programmable controller is configured for determining a sustainability score by means of the above described method. The term wavelength scanner is to be understood broadly in the present case and comprises a scanner that is configured to determine a wavelength of an atom or a molecule. The term wavelength scanner comprises scanners based on UV detection technique, a near infra-red detection technique, mid infra-red detection technique, an X-Ray fluorescence detection technique or neuron activation technique. The term programmable controller is to be understood broadly in the present case and comprises controller, which are configured to be programmed and controlled to execute the method described above. The term programmable controller comprises preferably a CPU of a smartphone, tablet, desktop pc, or a cloud. In this content, the plastic compound handling device preferably comprises a user interface, wherein the user interface is configured for displaying the determined sustainability score (e.g. display of a smartphone).

A further aspect of the present disclosure relates to a system for determining a sustainability score, comprising: a computer-based database comprising entries on a plurality of markers each identifying a specific plastic compound; at least one receiving unit configured to receive scan data from a sample of a plastic compound; at least one processing unit configured to identify a marker in the sample of the plastic compound based on the received scan data and the plurality of markers of the database; at least one processing unit configured to determine a sustainability score based on the identified marker of the sample of the plastic compound. The receiving unit and/or processing units may be distributed hardware components (e.g. separate CPUs), virtual components on one hardware component (e.g. central CPU). The receiving unit may comprise an interface with a specific communication standard (e.g. Ethernet, USB, HTML, NFC, Bluetooth, PCI etc.).

A further aspect of the present disclosure relates to a use of a computer-based database comprising entries on a plurality of markers each identifying a specific plastic compound and/or scan data from a sample of a plastic compound in a method described above.

A further aspect of the present disclosure relates to computer-implemented method for validating a sustainability score of a plastic compound, the method comprising:
receiving a sustainability score determined according to a method explained-above;
receiving a third party sustainability score linked to the plastic compound;
comparing the determined sustainability score and the third party sustainability score to validate the plastic compound and/or to validate if the plastic compound fulfils a predefined quality and/or predefined sustainability criteria.

In an embodiment, the step of identifying the marker comprises determining parameters from the previous lifecycle of the plastic compound based on the identified marker in said sample of the plastic compound and/or determining the content of recycled plastic of the plastic compound. Lifecycle refers to the period from production of the plastic compound till disposal and recycling of the same. The identified markers may be associated with a specific product and may therefor reveal the parameters from the previous lifecycle of the plastic compound. A share of determined markers in the sample may reveal the content of recycled plastic of the plastic compound. A material recycler may adapt the share of markers in the plastic compound each time he produces a plastic compound. In sum, this may be advantageous to refine the sustainability score of the plastic compound. For example every time a material recycler produces a plastic compound an additional marker may be added to the plastic compound. The marker may indicate the number of times the plastic compound has been recycled.

The present disclosure provides the possibility to calculate/estimate the carbon footprints (PCF) of recycled plastics and to provide measurements to help to reduce the product carbon footprints. Additional sustainability benefits can also be attributed to recycled material (global warming potential, cumulative energy demand, etc.). Increasingly, the industry is incorporating and expecting increasing amounts of bio-based content (e.g. plant based stearyl alcohol from palm/coconut/canola oil vs synthetic). Such bio-based content can be actively calculated and reported. Such content also leads to an overall lower PCF. A similar extrapolation can be made to biomass-balanced material, which could be marked with a digital tracer. A digital signal coming from a physical scan of a material could capture the certified inclusion of recycled material to demonstrate and track a (lower) PCF. Such information could be provided or be shared by providing respective databases and/or digital tools. For example, digital inputs from a physical marker could weight and aggregate various sustainability benefits to produce a standardized evaluation, similar to quality certifications such as ISO 9001. This data can then be carried forward into future PCFs or ‘cradle-to-cradle’ calculations.

### BRIEF DESCRIPTION OF THE DRAWINGS

In the following, the present disclosure is described exemplarily with reference to the enclosed figure, in which

FIG. 1 is a schematic overview of the steps of a method according to the present disclosure;

FIG. 2 is a schematic partial view of the plastic compound handling device according to the present disclosure;

FIG. 3 is an overview of an exemplary use case of the method according to the present disclosure;

FIG. 4 is an overview of a system according to the present disclosure;

FIG. 5 shows an exemplary application case of the method in a circular economy; and

FIG. 6 is a schematic overview of the steps for validating and controlling the further process of a plastic compound.

### DETAILED DESCRIPTION OF EMBODIMENT

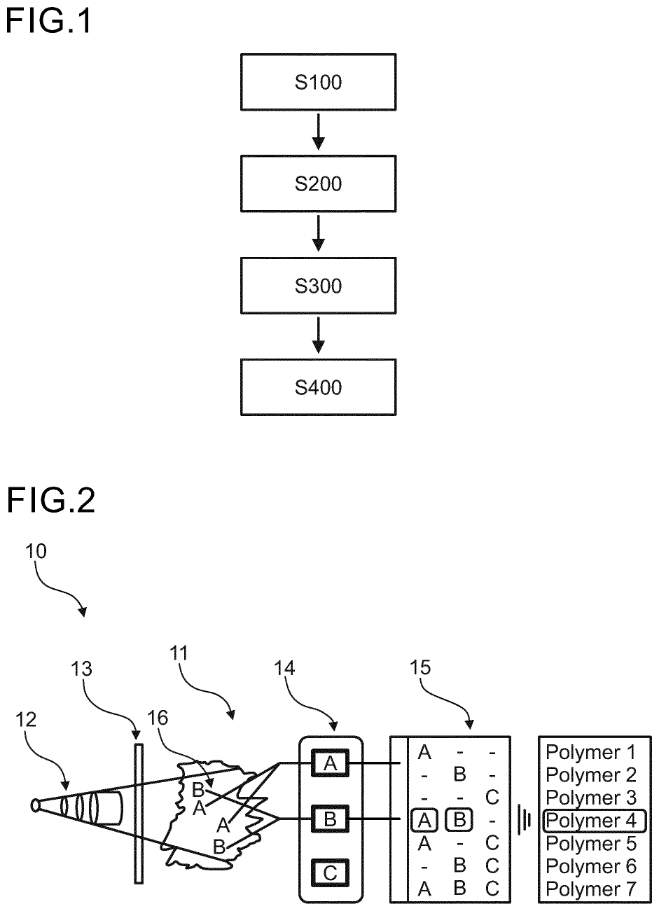

FIG. 1 shows a schematic overview of the steps of a method according to the present disclosure. The computer-implemented method for determining a sustainability score, comprises the step S100 of providing a computer-based database comprising entries on a plurality of markers each identifying a specific plastic compound. The identified markers reveal an ID for a specific plastic compound to which data is associated. In the present example the ID comprises a binary system with 5 digits (0 or 1) realized with 5 different markers. In case a marker is detected the respective digit is 1 otherwise 0. Hence, you are able to code 2\hat{ }5 different IDs with the markers. This will be further explained in FIG. 2. The data comprises in the present example batch size of the specific plastic compound, production data, target product and sustainability score. The sustainability comprises a metric from of ten stages from 1 to 10, wherein 1 is associated with a very low sustainability score and 10 is associated with a very high sustainability score. The database is in the present example a computer-based database, which is stored in a cloud. The entries of the specific plastic compounds are created from authorized plastic material producers. In step S200 scan data from a sample of a plastic compound is received. Preferably, the scan data comprises data from spectroscopic analysis. The markers used to code the specific plastic compound are chemical tracers. The chemical tracers show various spectroscopic properties and are therefore detectable via a spectroscopy. In step S300 a marker in the sample of the plastic compound is identified based on the received scan data and the plurality of markers of the database. The scan data for example reveals weather one or more markers are present in the spectroscopy measurement data or not. These results are matched with the entries of the database. In case of a positive match the data associated with the ID of the specific plastic compound is revealed. In a step S400 a sustainability score based on the identified marker of the sample of the plastic compound is determined. The sustainability score is in the present example a part of the data associated with the ID of a specific plastic compound. But the determination of the sustainability score is not limited to this example. It is further preferred that the received scan data of the sample, the identified marker of the sample and/or the determined sustainability score of the sample is uploaded into a block chain. By uploading these information into the block chain a ledger is extended and therefor generates a high transparency of the curriculum vitae the specific plastic compound. In this context the sustainability score may be determined by analysis of all existing entries to the block chain, which may result in a refined sustainability score.

FIG. 2 is a schematic partial view of the plastic compound handling device 10 according to the present disclosure. The plastic compound handling device 10, comprises a wavelength scanner 11, in the present example an X-ray fluorescence scanner, comprising an X-ray generator 12 as illumination source, a copper filter 13 for reducing noise of measurement and an X-ray fluorescence detection unit 14. The plastic compound system further comprises a programmable controller 15. The specific plastic compound 16 comprises two markers A and B. The X-ray generator 12 is configured generate X-rays and to direct them to specific plastic compound 16, wherein the X-ray excite the markers A, B. The markers are for example Fe and Ni. Each marker emits a unique radiation in X-ray fluorescence spectrometry, which depends on the atomic number of the element. The X-ray fluorescence scanner 14 is configured to for scanning a sample of the plastic compound 16, wherein scanning means detecting the emitted radiation of the markers. The X-ray fluorescence scanner is coupled with the programmable controller 15, which identifies the signature respectively the ID of the specific plastic compound 16. The programmable controller 15 is further configured for determining a sustainability score by means of the above described method.

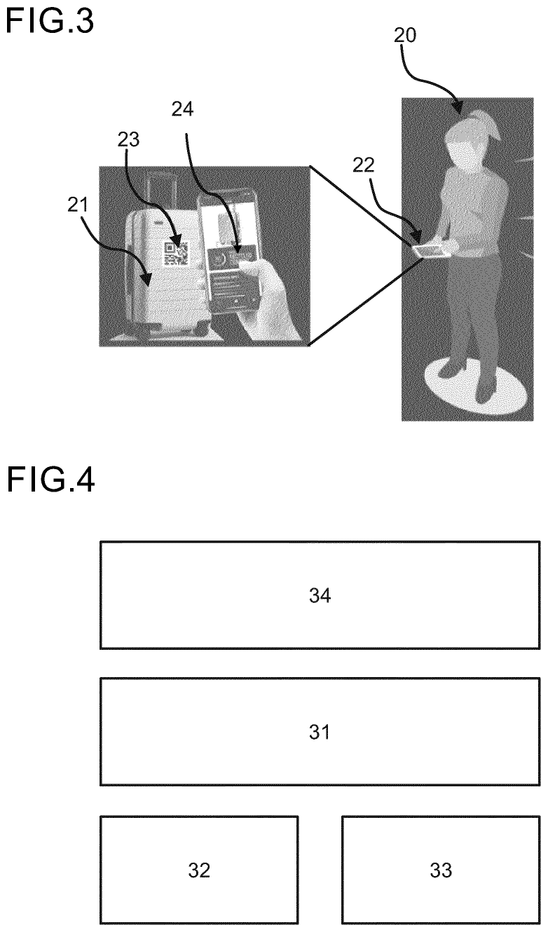

FIG. 3 is an overview of a use case of the method according to the present disclosure. In contrast to the description of FIGS. 1 and 2, the marker is not a chemical tracer, instead it is a QR-code 23. A user 20, which is interested in a sustainability score of a product 21, in this example a suitcase, scans with his smartphone 22 a QR-code 23 attached to the suitcase 21. On his smartphone 22 a computer-program element is executed and instructs a processor of the smartphone 22 to perform the method for determining a sustainability score. The determined sustainability score is further displayed on a user interface 24 of the smartphone 22.

FIG. 4 shows an overview of a system according to the present disclosure. The system 30 for determining the sustainability score comprises a computer-based database 31 comprising entries on a plurality of markers each identifying a specific plastic compound The system 30 further comprises one receiving unit 32 configured to receive scan data from a sample of a plastic compound. The system 30 further comprises one processing unit 33 configured to identify a marker in the sample of the plastic compound based on the received scan data and the plurality of markers of the database. The processing unit 33 is further configured to determine a sustainability score based on the identified marker of the sample of the plastic compound. The processing unit is further configured to upload the received scan data of the sample, the identified marker of the sample and/or the determined sustainability score of the sample is uploaded into a block chain 34. By uploading these information into the block chain 34 a ledger is extended and therefor generates a high transparency of the curriculum vitae the specific plastic compound. In this context the sustainability score may be further determined by analysis of all existing entries to the block chain 34, which may result in a refined sustainability score.

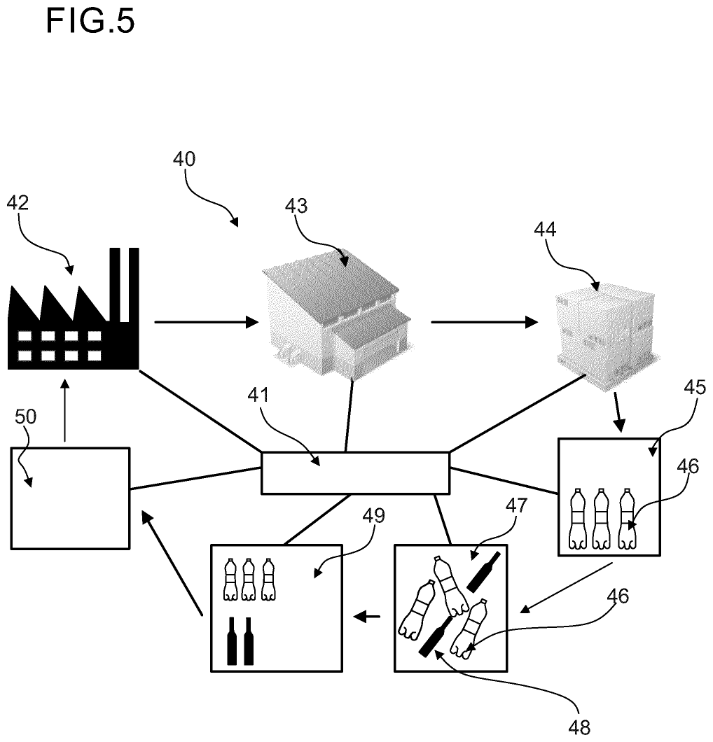

FIG. 5 shows an exemplary application case of the method in a circular economy 40. A plastic compound producer 42 may produce in a first step a specific plastic compound comprising a marker A. The corresponding data of the specific plastic compound may be transmitted to a digital platform 41, wherein the digital platform respectively the servers of the digital platform may store the corresponding data. The plastic compound producer 42 may sell the specific plastic compound to a manufacturer 43 for plastic bottles. The production data of the plastic bottles (e.g. time stamp, amount etc.) related to the specific plastic compound may be transmitted to the digital platform 41. The produced plastic bottles may comprise a QR-code and may then be shipped from the manufacturer 43 to a warehouse 44 for example in another country and from there to a retailer 45. The related transportation data for the plastic bottles 46 may each be transmitted the digital platform 41. Then a customer may buy the plastic bottle 46 from the retailer 45. The customer may check a sustainability score of the plastic bottle 46 according to the description of FIG. 3. The customer may dispose the plastic bottle 46 after use. A waste comprising the plastic bottle 46 and a further plastic bottle 48 with another marker B may then be collected by a waste disposal company 47. The waste disposal company 47 may have a sorting machine 49 that may works similar as the plastic handling device 10. The sorting machine 49 may identify the plastic bottle 46 with the specific plastic compound with the marker A. The collected data related to the plastic bottle 46 may be transmitted from the waste disposal company 47 to the digital platform 41. The waste disposal company 47 may sell the plastic bottle 46 to a recycling company 50 that produces a new specific plastic material. The recycling company 50 may add a further marker C to the plastic material and then may sell the plastic material to the plastic compound producer 42. The recycling company 50 may query the data related to the plastic bottle 46 from the digital platform 41 and further transmit new data to the digital platform 41.

It is further possible to validate a sustainability score of a plastic compound. This can be done, for example, by comparing a sustainability score determined as explained above with a sustainability score provided by a third party (e.g. plastic compound producer, manufacturer, retailer or disposal company). On the one hand, it can be determined whether both sustainability scores are essentially the same, and on the other hand, a release of the compound for further processing can be made dependent on this. This makes it possible to validate the determined sustainability score and to derive a control or process signal for the further process of the plastic compound from it.

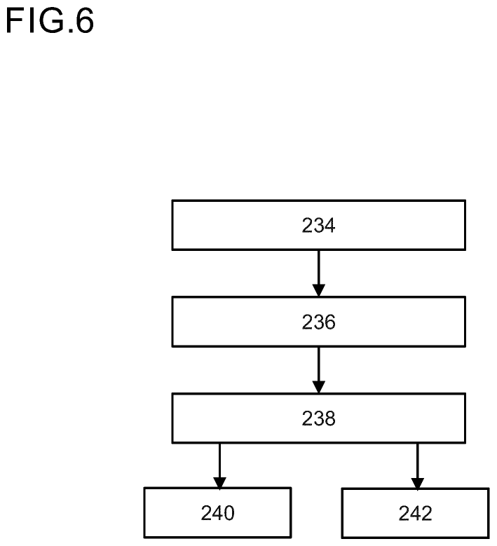

FIG. 6 shows an example of a flowchart for validating a sustainability score, preferably with respect to the content of recycled material and/or the number recycling loops of the recycled material, of the plastic compound with on at least one marker.

In a first step 234, a (third party) sustainability score linked to the plastic compound is provided, that might be provided by plastic compound producer, manufacturer, retailer or disposal company.

In a second step 236, a sustainability score is determined according to any of the methods explained above based on scan data associated with marker in a sample of the plastic compound.

In a third step 238, both sustainability scores (the determined and the provided) can be compared in order to validate the plastic compound. For example, if the comparison lies within an acceptable/predetermined range, the sustainability score is considered to be valid. If the comparison does not lie within an acceptable/predetermined range, the sustainability score is considered not to be valid.

If sustainability score is considered to be valid, a control signal for a further processing of the plastic compound may be triggered in step 240.

If the sustainability score is invalid, a warning signal for the operator of the process may be triggered in step 242. Such warning signal may signify the invalidity of the sustainability score. Moreover, a stop signal may be triggered stopping/interrupting the further processing of the plastic compound.

The present disclosure has been described in conjunction with a preferred embodiment as examples as well. However, other variations can be understood and effected by those persons skilled in the art and practicing the claimed invention, from the studies of the drawings, this disclosure and the claims. Notably, in particular the described steps can be performed in any order, i.e. the present disclosure is not limited to a specific order of these steps. Moreover, it is also not required that the different steps are performed at a certain place or at one place, i.e. each of the steps may be performed at a different place using different equipment/data processing units. In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

### REFERENCE LIST

10 plastic compound handling device
11 wavelength scanner
12 X-ray generator
13 copper filter
14 X-ray fluorescence scanner
15 programmable controller
16 plastic compound
20 user
21 product
22 smartphone
23 QR-code
24 display of user interface
25 system
31 database
32 receiving unit
33 processing unit
34 block chain
40 circular economy
41 digital platform
42 plastic compound producer
43 manufacturer
44 warehouse
45 retailer
46, 48 plastic bottle
47 waste disposal company
49 sorting machine
50 recycling company

1: A computer-implemented method for determining a sustainability score, comprising:
providing a computer-based database comprising entries on a plurality of markers each identifying a specific plastic compound;
receiving scan data from a sample of a plastic compound;
identifying a marker in the sample of the plastic compound based on the received scan data and the plurality of markers of the database; and
determining a sustainability score based on the identified marker of the sample of the plastic compound.

2: The computer-implemented method according to claim 1, comprising:
receiving a block chain storing a plurality of scan data of samples, a plurality of identified markers of samples, and/or a plurality of sustainability scores of samples; and
uploading into the block chain the received scan data of the sample, the identified marker of the sample, and/or the determined sustainability score of the sample.

3: The computer-implemented method according to claim 2, wherein the of determining of the sustainability score comprises:
identifying in the block chain at least one data entry associated with the identified marker of the sample; and
determining the sustainability score based on the at least one data entry and the identified marker.

4: The computer-implemented method according to claim 1, wherein the identifying of the marker comprises:
determining a type and/or a quantity of the marker in the sample of the plastic compound.

5: The computer-implemented method according to claim 1, wherein the identifying of the marker comprises:
determining a weight portion of the marker in the sample of the plastic compound.

6: The computer-implemented method according to claim 1, comprising:
determining based on the sustainability score an emission footprint, over the lifetime of the sample of the plastic compound.

7: The computer-implemented method according to claim 1, comprising:
determining based on the sustainability score a fluid usage, over the lifetime of the sample of the plastic compound.

8: The computer-implemented method according to claim 1, comprising:
generating a signal, which comprises the command to display the determined sustainability score on a user interface.

9: The computer-implemented method according to claim 1, wherein the marker is selected from the group consisting of UV marker, XRD marker, XRF marker, QR code, and steganographic feature.

10: The computer-implemented method according to claim 1, wherein the sample of the plastic compound comprises one or more elements selected from the group consisting of: low density polyethylene (LDPE), linear LDPE (LLDPE), high density polyethylene (HDPE), polyoxmethylene (POM) polypropylene (PP), polyamide (PA), poly ethylene terephthalate (PET), poly butylene terephthalate (PBT), acrylonitrile-butadiene-styrene (ABS), polymethylmethacrylate (PMMA), thermoplastic polyurethane (TPU), polystyrene (PS), polylactic acid (PLA), polyvinylchloride (PVC), and polycarbonate (PC).

11: The computer-implemented method according to claim 1, further comprising:
providing a determined sustainability score suitable for controlling the further processing of the plastic compound.

12: The computer-implemented method according to claim 1, further comprising:
providing a determined sustainability score for validating a received sustainability score of the plastic compound.

13: A computer program element, which, when executed, instructs a processor to perform any one of the steps of the method according to claim 1.

14: A computer readable medium, storing the computer program element according to claim 13.

15: A plastic compound handling device, comprising:
a wavelength scanner; and
a programmable controller;
wherein the wavelength scanner is configured for scanning a sample of a plastic compound;
wherein the programmable controller is configured for determining a sustainability score by the method according to claim 1.

16: The plastic compound handling device according to claim 15, comprising:
a user interface, wherein the user interface is configured for displaying the determined sustainability score.

17: A system for determining a sustainability score, comprising:
a computer-based database comprising entries on a plurality of markers each identifying a specific plastic compound;
at least one receiving unit configured to receive scan data from a sample of a plastic compound;
at least one processing unit configured to identify a marker in the sample of the plastic compound based on the received scan data and the plurality of markers of the database; and
at least one processing unit configured to determine a sustainability score based on the identified marker of the sample of the plastic compound.

18. (canceled)

19: A computer-implemented method for validating a sustainability score of a plastic compound, the method comprising:
receiving a sustainability score determined according to the method of claim 1;
receiving a third party sustainability score linked to the plastic compound; and
comparing the determined sustainability score and the third party sustainability score to validate the plastic compound and/or to validate if the plastic compound fulfils a predefined quality and/or predefined sustainability criteria.

20: The computer-implemented method according to claim 12, wherein the content of recycled material and/or the number recycling loops of the recycled material of the plastic compound is/are validated.
